(19) United States
(12) Patent Application Publication
(10) Pub. No.: US 2008/0231580 A1
(43) Pub. Date: Sep. 25, 2008

(54) LCD Device Driven by Pre-charge Procedure

(76) Inventor: Chin-Hung Hsu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/750,336

(22) Filed: May 18, 2007

(30) Foreign Application Priority Data
Mar. 21, 2007 (TW) 096109729

(51) Int. Cl. G09G 3/36

(52) U.S. Cl. 345/98

(57) ABSTRACT

The LCD device driven by a pre-charge procedure includes a source driver for generating data signals, a gate driver for generating gate signals, a plurality of data lines for receiving data signals, a plurality of gate lines for receiving gate signals, a plurality of display units for displaying data signals, a pre-charge controller for generating control signals, a plurality of dummy gate lines parallel to the plurality of gate lines for receiving the control signals, a plurality of voltage sources for providing a plurality of voltage levels, and a plurality of dummy switches for pre-charging the voltage levels of the corresponding data lines to specific voltage levels according to the signals of the corresponding dummy gate lines received by the control ends of the dummy switches.

### BACKGROUND OF THE INVENTION

1. Field of the Invention

The present invention related to an LCD device driven by a pre-charge procedure, and more particularly, to an LCD device capable of saving power needed to be provided by a source driver by utilizing external voltage sources for raising or lowering voltage levels of data lines to specific values in advance.

2. Description of the Prior Art

Due to advantages such as low radiation, thin appearance and low power consumption, liquid crystal display (LCD) devices have gradually replaced traditional cathode ray tube (CRT) displays and have been widely used in notebook computers, monitors, personal digital assistants (PDA), flat panel televisions and mobile phones.

Please refer to FIG. 1. FIG. 1 is a schematic diagram of a prior art LCD device 10. The LCD device 10 includes an LCD panel 120, a timing controller 140, a source driver 160, and a gate driver 180. The LCD panel 120 includes a plurality of parallel data lines D1-Dm, a plurality of parallel gate lines G1-Gn, and a plurality of display units P11-Pmn. The data lines D1-Dm and the gate lines G1-Gn are crossed with each other, and each of the display units P11-Pmn is disposed at an intersection of a corresponding data line and a corresponding gate line. The timing controller 140 can generate data signals corresponding to display images, as well as control signals and clock signals for driving the LCD panel 120. According to signals received from the timing controller 140, the gate driver 180 and the source driver 160 generate corresponding gate signals and driving signals respectively. Each display unit of the LCD panel 120 includes a thin film transistor (TFT) switch and an equivalent capacitor. Each equivalent capacitor has an end coupled to a corresponding data line via a corresponding TFT switch, and another end coupled to a common voltage V_{com}. When the TFT switch of a display unit is turned on by a gate signal generated by the gate driver 180, the equivalent capacitor of the display unit is electrically connected to its corresponding data line and can thus receive a driving voltage from the source driver 160. Therefore, the display unit can display images of various gray scales by changing the rotation of liquid crystal molecules based on charges stored in the equivalent capacitor.

With increasing demands in large-size applications, the panel loading and dynamic power consumption also increase as the LCD panel becomes larger. As a result, it is a main concern to lower power consumption when designing an LCD device. Generally speaking, in order to avoid permanent polarization of liquid crystal materials, the polarities of voltages applied to both ends of equivalent capacitors have to be reversed periodically. Common methods for driving LCD panels include dot inversion, column inversion and line inversion. When the driving voltages of an LCD device begin to reverse respective polarities, the LCD device has the largest loading since the source driver consumes the largest amount of current at this point of time.

Assuming dot-inversion is used for driving the LCD panel 120 of the LCD device 10, among the driving voltages outputted by the source driver 160 to the data lines D1-Dm, half of them are higher than the common voltage V_{com}, while the other half are lower than the common voltage V_{com}. In other words, during positive driving periods, the source driver 160 outputs a driving voltage V_{PIXEL}_{_{—}}_{POSITIVE} higher than the common voltage V_{com} to odd-numbered data lines D1-Dm-1, and outputs a driving voltage V_{PIXEL}_{_{—}}_{NEGATIVE} lower than the common voltage V_{com} to even-numbered data lines D2-Dm. During negative driving periods, the source driver 160 outputs the driving voltage V_{PIXEL}_{_{—}}_{NEGATIVE} to odd-numbered data lines D1-Dm-1, and outputs the driving voltage V_{PIXEL}_{_{—}}_{POSITIVE} to even-numbered data lines D2-Dm. The values of the driving voltages V_{PIXEL}_{_{—}}_{POSITIVE} and V_{PIXEL}_{_{—}}_{NEGATIVE} depend on the gray scales of display images.

Please refer to FIG. 2. FIG. 2 is a schematic diagram of a driving voltage signal of a data line outputted by the source driver 160. In FIG. 2, the transverse axle represents time, the vertical axle represents voltage level, V_{P} and V_{N} respectively represent the maximum and the minimum voltage level of the driving voltage signal S_OUT outputted by the source driver 160, and V_{com} represents the voltage level of the common voltage. At the end of a previous negative driving period (at time T1), the driving voltage V_{PIXEL}_{_{—}}_{NEGATIVE} outputted by the source driver 160 is equal to the minimum driving voltage V_{N}, and during the current positive driving period (between time T1 and T2), the driving voltage V_{PIXEL}_{_{—}}_{POSITIVE} outputted by the source driver 160 is equal to the maximum driving voltage VP. Therefore, when the LCD device 10 performs polarity reversal (from negative to positive), the energy ΔV provided by the source driver 160 is |V_{P}-V_{N}|, which is just equal to the maximum energy needed to be provided by the source driver 160. Conversely, during a next negative driving period (between time T2 and T3), the driving voltage V_{PIXEL}_{_{—}}_{NEGATIVE} outputted by the source driver 160 is equal to the minimum driving voltage V_{N}. Therefore, when the LCD device 10 performs polarity reversal (from positive to negative), the maximum energy ΔV needed to be discharged by the source driver 160 is |V_{N}-V_{P}|.

As mentioned above, when the driving voltages of the LCD panel begin to reverse polarities, the LCD device has the largest loading since the source driver 160 consumes the largest amount of current at this point of time. Therefore, it is an important concern to lower the maximum energy ΔV needed to be provided by the source driver 160. In prior arts, charge sharing is normally applied for reducing power consumption in an LCD device. Before the source driver 160 outputs driving signals, charge sharing can halve the amount of dynamic current by rearranging charges of adjacent data lines with opposite polarities. However, in this way, a heat dissipation problem of source driving ICs in large-size panel applications cannot be overcome completely.

### SUMMARY OF THE INVENTION

It is therefore a primary objective of the present invention to provide an LCD device driven by pre-charge procedure.

The present invention discloses an LCD device driven by a pre-charge procedure. The LCD device includes a source driver for generating data signals corresponding to display images; a gate driver for generating gate signals; a plurality of parallel data lines coupled to the source driver for receiving the data signals; a plurality of parallel gate lines, coupled to the gate driver and crossed with the plurality of data lines perpendicularly, for receiving the gate signals; a plurality of data switches, each comprising a first end coupled to a storage unit; a second end coupled to a data line of the plurality of data lines; and a control end coupled to a gate line of the plurality of gate lines, wherein the data switch controls a signal connection between the second end and the first end according to a signal of the gate line received by the control end; a pre-charge controller for generating a plurality of control signals; a plurality of dummy gate lines, coupled to the pre-charge controller and parallel to the plurality of gate lines, for receiving the plurality of control signals generated by the pre-charge controller; a plurality of voltage sources for providing a plurality of voltage levels; and a plurality of dummy switches, each comprising a first end coupled to a voltage source of the plurality of voltage sources; a second end coupled to a data line of the plurality of data lines; and a control end coupled to a dummy gate line of the plurality of dummy gate lines, wherein the dummy switch controls a signal connection between the second end and the first end according to a signal of the dummy gate line received by the control end.

The present invention further discloses an LCD device driven by a pre-charge procedure. The LCD device includes a source driver for generating data signals corresponding to display images; a gate driver for generating gate signals; a plurality of parallel data lines coupled to the source driver for receiving the data signals; a plurality of parallel gate lines, coupled to the gate driver and crossed with the plurality of data lines perpendicularly, for receiving the gate signals; a plurality of data switches, each comprising a first end coupled to a storage unit; a second end coupled to a data line of the plurality of data lines; and a control end coupled to a gate line of the plurality of gate lines, wherein the data switch controls a signal connection between the second end and the first end according to a signal of the gate line received by the control end; a pre-charge controller for generating a control signal; a dummy gate line, coupled to the pre-charge controller and parallel to the plurality of gate lines, for receiving the control signal generated by the pre-charge controller; a plurality of voltage sources for providing a plurality of voltage levels; a switch unit coupled to the plurality of voltage sources for switching to output a voltage of the plurality of voltage sources according to a second control signal; and a plurality of dummy switches, each comprising: a first end coupled to the switch unit; a second end coupled to a data line of the plurality of data lines; and a control end coupled to the dummy gate line, wherein the dummy switch controls a signal connection between the second end and the first end according to a signal of the dummy gate line received by the control end.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a prior art LCD device.

FIG. 2 is a schematic diagram of a driving voltage signal of a data line outputted by the source driver.

FIG. 3 is a schematic diagram of an LCD device driven by pre-charge procedure according to the present invention.

FIG. 4 is a schematic diagram of timing sequences of corresponding signals in the LCD device of the present invention.

FIG. 5 is a schematic diagram of a pre-charge circuit according to the present invention.

FIG. 6 and FIG. 7 are schematic diagrams of LCD devices 60 and 70 driven by pre-charge procedure according to embodiments of the present invention.

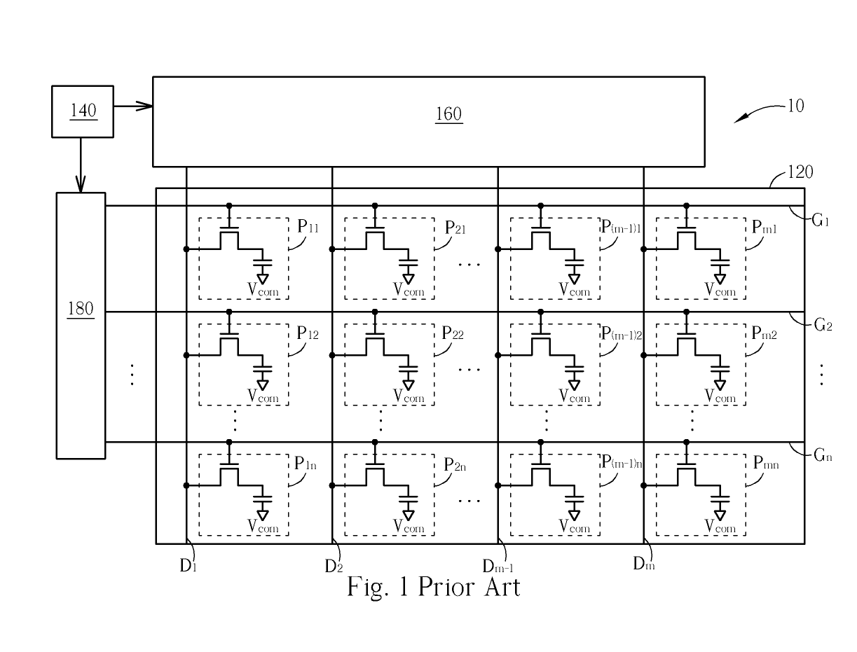

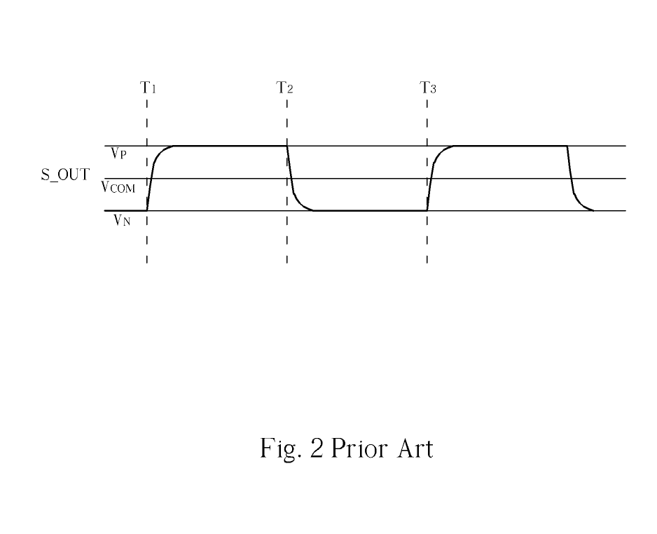

### DETAILED DESCRIPTION

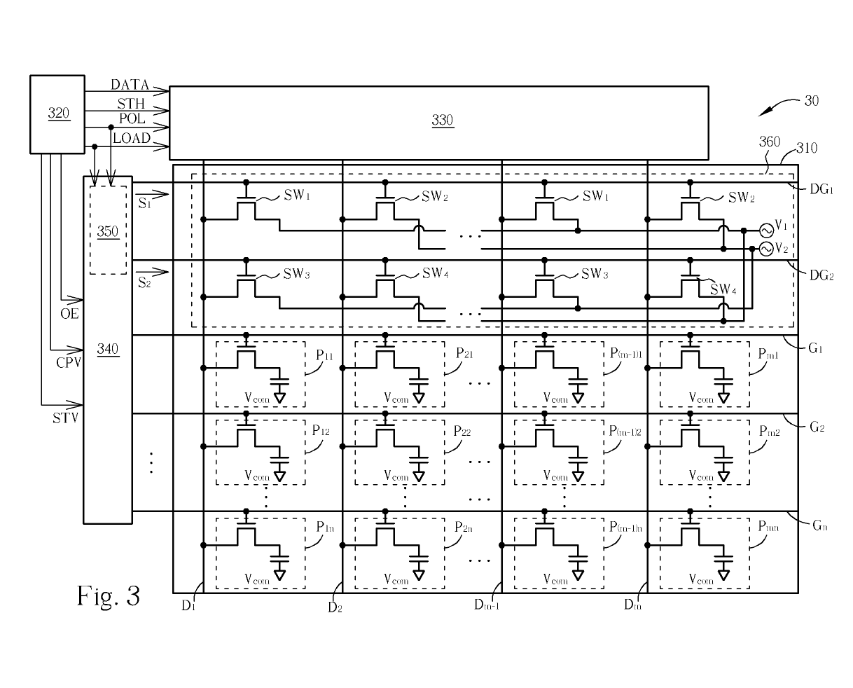

Please refer to FIG. 3. FIG. 3 is a schematic diagram of an LCD device 30 driven by pre-charge procedure according to the present invention. The LCD device 30 includes an LCD panel 310, a timing controller 320, a source driver 330, a gate driver 340, and a pre-charge controller 350. On the LCD panel 310 are set parallel data lines D1-Dm, parallel gate lines G1-Gn, a pre-charge circuit 360, and display units P11-Pmn. The data lines D1-Dm and the gate lines G1-Gn are crossed with each other, and each of the display units P11-Pmn is disposed at an intersection of a corresponding data line and a corresponding gate line. The timing controller 320 is utilized for generating data signals DATA corresponding to display images of the LCD panel 310, as well as a source clock signal CPH, a horizontal initiation signal STH, a polarity control signal POL, a data load signal LOAD, a vertical initiation signal STV, a gate clock signal CPV and an output enable signal OE for driving the LCD panel 310. The source driver 330 generates source driving signals corresponding to the data lines D1-Dm based on the data signals DATA, the source clock signal CPH, the horizontal initiation signal STH, the polarity control signal POL, and the data load signal LOAD outputted by the timing controller 320. The gate driver 340 generates gate driving signals corresponding to the gate lines G1-Gn based on the vertical initiation signal STV, the gate clock signal CPV and the output enable signal OE outputted by the timing controller 320. The pre-charge controller 350 can be set on the gate driver 340, and is utilized for generating a first control signal S1 and a second control signal S2 to control the pre-charge circuit 360 of the LCD panel 310 based on the polarity control signal POL and the data load signal LOAD outputted by the timing controller 320. Each display unit of the LCD panel 310 includes a TFT switch and an equivalent capacitor. Each equivalent capacitor has an end coupled to a corresponding data line via a corresponding TFT switch, and another end coupled to a common voltage V_{com}. When the TFT switch of a display unit is turned on by a gate signal generated by the gate driver 340, the equivalent capacitor of the display unit is electrically connected to its corresponding data line and can thus receive a driving voltage from the source driver 330. Therefore, the display unit can display images of various gray scales by changing the rotation of liquid crystal molecules based on charges stored in the equivalent capacitor.

The pre-charge circuit 360 is disposed on the LCD panel 310, and includes a first dummy gate line DG1, a second dummy gate line DG2, a first voltage source V1, a second voltage source V2 and a plurality of first through fourth dummy switches SW1-SW4. The dummy gate lines DG1 and DG2, parallel to the gate lines G1-Gn, can respectively receive the first control signal S1 and the second control signal S2 from the pre-charge controller 350. The first voltage source V1 and the second voltage source V2 are utilized for providing a first voltage level V_{PH} higher than the common voltage V_{com} and a second voltage level V_{PL} lower than the common voltage V_{com} respectively.

Each of the first dummy switches SW1 is disposed at an intersection of the first dummy gate line DG1 and a corresponding odd-numbered data line (D1, D3, . . . , or Dm-1), and is coupled between the first voltage source V1 and the corresponding odd-numbered data line (D1, D3, . . . , or Dm-1). When the first dummy switches SW1 are turned on due to the first control signal S1 being applied to respective control ends via the first dummy gate line DG1, the odd-numbered data lines D1-Dm-1 are electrically connected to the first voltage source V1.

Each of the second dummy switches SW2 is disposed at an intersection of the first dummy gate line DG1 and a corresponding even-numbered data line (D2, D4, . . . , or Dm), and is coupled between the second voltage source V2 and the corresponding even-numbered data line (D2, D4, . . . , or Dm). When the second dummy switches SW2 are turned on due to the first control signal S1 being applied to respective control ends via the first dummy gate line DG1, the even-numbered data lines D2-Dm are electrically connected to the second voltage source V2.

Each of the third dummy switches SW3 is disposed at an intersection of the second dummy gate line DG2 and a corresponding odd-numbered data line (D1, D3, . . . , or Dm-1), and is coupled between the second voltage source V2 and the corresponding odd-numbered data line (D1, D3, . . . , or Dm-1). When the third dummy switches SW3 are turned on due to the second control signal S2 being applied to respective control ends via the second dummy gate line DG2, the odd-numbered data lines D1-Dm-1 are electrically connected to the second voltage source V2.

Each of the fourth dummy switches SW4 is disposed at an intersection of the second dummy gate line DG2 and a corresponding even-numbered data line (D2, D4, . . . , or Dm), and is coupled between the first voltage source V1 and the corresponding even-numbered data line (D2, D4, . . . , or Dm). When the fourth dummy switches SW4 are turned on due to the second control signal S2 being applied to respective control end via the second dummy gate line DG2, the even-numbered data lines D2-Dm are electrically connected to the first voltage source V1.

Therefore, before the source driver 330 outputs the driving voltages to the LCD panel 310, the LCD device 30 of the present invention can first adjust the voltage level of each data line through the pre-charge circuit 360. Taking the first data line D1 for example, when during a positive driving period, display data of each display unit of the first data line D1 is corresponding to a positive driving voltage V_{PIXEL}_{_{—}}_{POSITIVE}, and before the source driver 330 outputs the driving voltage V_{PIXEL}_{_{—}}_{POSITIVE}, the pre-charge controller 350 can output the first control signal S1 to the first dummy gate line DG1 for turning on the first dummy switch SW1 coupled to the first dummy gate line DG1 and the first data line D1 according to the polarity control signal POL and the data load signal LOAD outputted by the timing controller 320. Therefore, the first data line D1 is electrically connected to the first voltage source V1, such that the voltage level of the first data line D1 can be raised to the voltage level V_{PH} higher than the common voltage V_{com} before the driving voltage V_{PIXEL}_{_{—}}_{POSITIVE} arrives. After the voltage level of the first data line D1 is raised to the value V_{PH}, the source driver 330 can then output the driving voltage V_{PIXEL}_{_{—}}_{POSITIVE} according to the data load signal LOAD, and thus the source driver 330 only needs to provide the energy |V_{PIXEL}_{_{—}}_{POSITIVE}-V_{PH}| for the display units of the first data line D1 to display the correct image data.

Conversely, when during a negative driving period, the display data of each display unit of the first data line D1 is corresponding to a negative driving voltage V_{PIXEL}_{_{—}}_{NEGATIVE}, and before the source driver 330 outputs the driving voltage V_{PIXEL}_{_{—}}_{NEGATIVE}, the pre-charge controller 350 can output the second control signal S2 to the second dummy gate line DG2 for turning on the third dummy switch SW3 coupled to the second dummy gate line DG2 and the first data line D1 according to the polarity control signal POL and the data load signal LOAD. Therefore, the first data line D1 is electrically connected to the second voltage source V2, such that the voltage level of the first data line D1 can be lowered to the value V_{PL} lower than the common voltage V_{com} in advance before the driving voltage V_{PIXEL}_{_{—}}_{NEGATIVE} arrives. Then, the source driver 330 can output the driving voltage V_{PIXEL}_{_{—}}_{NEGATIVE} according to the data load signal LOAD, and thus the source driver 330 only needs the energy |V_{PIXEL}_{_{—}}_{NEGATIVE}-V_{PL}| for the display units of the first data line D1 to display the correct image data.

In like manners, the odd-numbered data lines (D1, D3, . . . , Dm-1) of the LCD panel 310 can utilize the first control signal S1 outputted by the pre-charge controller 350 to raise their own voltage levels to the value V_{PH} in advance via the corresponding first dummy switches SW1 before the source driver 330 outputs the positive driving voltage V_{PIXEL}_{_{—}}_{POSITIVE}, and utilize the second control signal S2 outputted by the pre-charge controller 350 to lower their own voltage levels to the value V_{PL} in advance via the corresponding third dummy switches SW3 before the source driver 330 outputs the negative driving voltage V_{PIXEL}_{_{—}}_{NEGATIVE}. Similarly, the even-numbered data lines (D2, D4, . . . , Dm) can utilize the second control signal S2 outputted by the pre-charge controller 350 to raise their own voltage levels to the value V_{PH} in advance via the corresponding forth dummy switches SW4 before the source driver 330 outputs the positive driving voltage V_{PIXEL}_{_{—}}_{POSITIVE}, and utilize the first control signal S1 outputted by the pre-charge controller 350 to lower their own voltage levels to the value V_{PL} in advance via the corresponding second dummy switches SW2 before the source driver 330 outputs the negative driving voltage V_{PIXEL}_{_{—}}_{NEGATIVE}. Therefore, if dot inversion is used for driving the LCD panel 310, with the arrangement of the pre-charge circuit 360 of the present invention, the voltage levels of adjacent data lines can be pre-charged to the voltage levels with different polarities by utilizing the same control signal before the source driver 330 outputs the driving voltages, so that the power consumed by the source driver 330 can be reduced.

Therefore, by using the pre-charge controller 350 and the pre-charge circuit 360, the LCD device 30 of the present invention can utilize the external first voltage source V1 and second voltage source V2 to pre-charge the voltage level of each data line to the desired polarities, so that the dynamic current passing through the source driver 330 can be reduced, and thus the power consumed by the source driver 330 can be saved enormously.

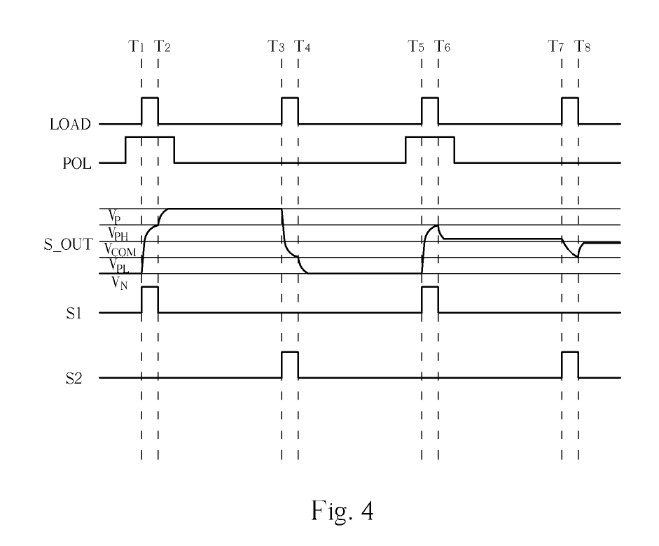

Please refer to FIG. 4. FIG. 4 is a schematic diagram of timing sequences of corresponding signals in the LCD device 30 of the present invention. Timing points T1,T3 . . . are respectively corresponding to rising edges of the data load signal LOAD, and timing points T2, T4 . . . are respectively corresponding to descending edges of the data load signal LOAD. V_{P} and V_{N} respectively represent the maximum and the minimum voltage level of the driving voltage signal S_OUT outputted by the source driver 330, and V_{com} represents the voltage level of the common voltage. Thus, during a positive driving period, the positive driving voltage V_{PIXEL}_{_{—}}_{POSITIVE} outputted by the source driver 330 lies in between the common voltage V_{com} and the maximum driving voltage V_{P} while during a negative driving period, the outputted negative driving voltage V_{PIXEL}_{_{—}}_{NEGATIVE} lies in between the common voltage V_{com} and the minimum driving voltage V_{N}. The source driver 330 can determine the polarities of the driving voltage being outputted according to the logic level of the polarity control signal POL outputted by the timing controller 320. When the logic level of the polarity control signal POL is high, the source driver 330 outputs the positive driving voltage V_{PIXEL}_{_{—}}_{POSITIVE}. Conversely, when the logic level of the polarity control signal POL is low, the negative driving voltage V_{PIXEL}_{_{—}}_{NEGATIVE} is outputted. After utilizing the polarity control signal POL for determining the polarities of the driving voltages, the source driver 330 can be triggered to output the driving voltages according to descending edges of the data load signal LOAD outputted by the timing controller 320.

Furthermore, as mentioned above, before the source driver 330 outputs the driving voltages, the pre-charge controller 350 can be triggered to output the first control signal S1 or the second control signal S2 for raising or lowering the voltage levels of the data lines to the value V_{PH} or V_{PL} according to rising edges of the data load signal LOAD and the polarities of the driving voltages determined by the polarity control signal POL, so as to reduce the power consumption of the source driver 330. Therefore, in FIG. 4, taking the first data line D1 for example, at the rising edge of the data load signal LOAD (the timing point T1), the pre-charge controller 350 utilizes the polarity control signal POL for determining the driving voltage outputted by the source driver 330 is positive, and outputs the first control signal S1 for turning on the first dummy switch SW1 to raise the voltage level of the first data line D1 to the value V_{PH} in advance. At the descending edge of the data load signal LOAD (the timing point T2), the first dummy switch SW1 is turned off by the first control signal S1. Meanwhile, the source driver 330 outputs the positive driving voltage V_{PIXEL}_{_{—}}_{POSITIVE}, of which the value is equal to the maximum value V_{P} of the driving voltages. In this case, the energy ΔV needed to be provided by the source driver 330 is only |V_{P}-V_{PH}|. Since the variation range of the positive driving voltage V_{PIXEL}_{_{—}}_{POSITIVE} lies in between the maximum value V_{P} of the driving voltages and the common voltage V_{com}, whenever the driving period is reversed to a positive driving period, the maximum energy needed to be provided by the source driver 330 is merely |V_{P}-V_{PH}| or |V_{PH}-V_{com}|, as shown at the timing point T6.

Similarly, at another rising edge of the data load signal LOAD (the timing point T3), the pre-charge controller 350 utilizes the polarity control signal POL for determining the driving voltage outputted by the source driver 330 is negative, and outputs the second control signal S2 for turning on the third dummy switch SW3 to lower the voltage level of the first data line D1 to the value V_{PL} in advance. At the descending edge of the data load signal LOAD (the timing point T4), the third dummy switch SW3 is turned off by the second control signal S2. Meanwhile, the source driver 350 outputs the negative driving voltage V_{PIXEL}_{_{—}}_{NEGATIVE}, of which the value is equal to the minimum value V_{N} of the driving voltage. In this case, the energy ΔV needed to be provided by the source driver 330 is only |V_{PL}-V_{N}|. Since the variation range of the negative driving voltage V_{PIXEL}_{_{—}}_{NEGATIVE} lies in between the minimum value V_{N} of the driving voltages and the common voltage V_{com}, whenever the driving period is reversed to a negative driving period, the maximum energy needed to be provided by source driver 330 is merely |V_{PL}-V_{N}|, or |V_{com}-V_{PL}|, as shown at the timing point T8. Therefore, V_{P}>=V_{PH}>V_{com}, and V_{com}>=V_{PL}>V_{N}.

Therefore, compared with the prior art, whenever polarity reversal is performed, the LCD device 30 of the present invention utilizes the pre-charge controller 350 and the pre-charge circuit 360 for raising or lowering the voltage level of the data lines to specific values in advance to reduce the energy needed to be provided by the source driver 330. Furthermore, the pre-charge circuit 360 of the present invention utilizes external voltage sources to achieve the pre-charge procedure, and thus the dynamic current passing through the source driver 330 can be reduced greatly, so as to improve the heat dissipation problem of the source driver 330 in large-size panel applications.

Please note that the pre-charge circuit 360 of the present invention is not restricted to two dummy gate lines. Those skilled in the art can expand the pre-charge circuit 360 to a plurality of dummy gate lines for providing more elastic driving manners according to practical demands. The plurality of dummy gate lines can be utilized for receiving a plurality of control signals transmitted from the pre-charge controller 350 for electrically connecting each data line to a plurality of voltage sources via a plurality of dummy switches. Therefore, before the source driver 330 outputs the driving voltages, each data line can be pre-charged to a plurality of different voltage levels via a corresponding dummy switch according to the control signals outputted by the pre-charge controller 350. For example, when during the positive driving period, each data line can be electrically connected to different voltage sources with different positive voltage levels through a corresponding dummy gate line and a corresponding dummy switch. When during the negative driving period, each data line can be electrically connected to different voltage sources with different negative voltage levels through a corresponding dummy gate line and a corresponding dummy switch. In this way, the pre-charge controller 350 can determine to output the corresponding control signals based on the driving voltages outputted by the source driver 330, and pre-charge the voltage level of the data lines to the value closer to the driving voltages, so as to reduce the power consumption of the source driver 330 and provide more elastic driving manners.

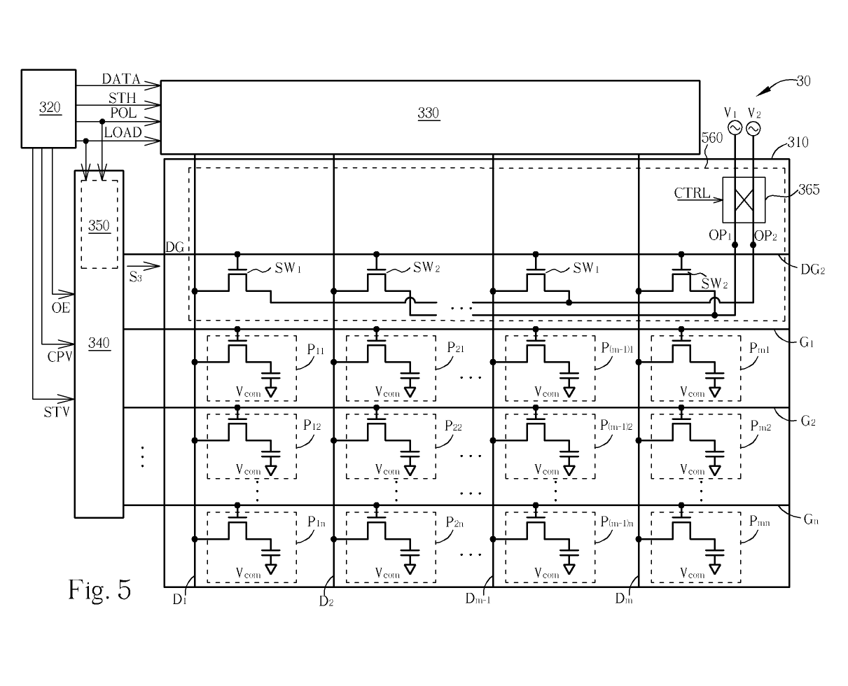

Compared with the plurality of dummy gate lines, the pre-charge circuit 360 of the present invention can further utilize a dummy gate line and a switch unit for pre-charging the voltage level of the data lines to specific values to reduce the power consumption of the source driver 330. Please refer to FIG. 5. FIG. 5 is a schematic diagram of a pre-charge circuit 560 according to the present invention. The pre-charge circuit 560 can substitute for the pre-charge circuit 360 of FIG. 3, which includes a dummy gate line DG, a plurality of first and second dummy switches SW1 and SW2 and a switch unit 365. The dummy gate line DG, coupled to the pre-charge controller 350 and parallel to the gate lines G1-Gn, is utilized for receiving a control signal S3 generated by the pre-charge controller 350. Each first dummy switch SW1 is coupled between a corresponding odd-numbered data line (D1, D3, . . . , Dm-1) and the switch unit 365. When each of the first dummy switch SW1 is turned on due to the control signal S3 being applied to respective control ends via the dummy gate line DG, the odd-numbered data lines D1-Dm-1 are electrically connected to a first output terminal OP1 of the switch unit 365. Each second dummy switch SW2 is coupled between a corresponding even-numbered data line and the switch unit 365. When each of the second dummy switch SW2 is turned on due to the control signal S3 being applied to respective control ends via the dummy gate line DG, the even-numbered data lines D2-Dm are electrically connected to a second output terminal OP2 of the switch unit 365. The switch unit 365 is coupled to the first voltage source V1 and the second voltage source V2, and is utilized for switching the first and the second output terminals OP1 and OP2 to output the voltages V_{PH} and V_{PL} of the first and second voltage sources according to a switch control signal CTRL.

Preferably, the switch control signal CTRL can be the polarity control signal POL. Taking the first data line D1 for example, when display data of a display unit of the first data line D1 is corresponding to a positive driving voltage V_{PIXEL}_{_{—}}_{POSITIVE}, the pre-charge controller 350 can output the control signal S3 to the dummy gate line DG for turning on the first dummy switch SW1 according to the polarity control signal POL and the data load signal LOAD outputted by the timing controller 320 before the source driver 330 outputs the driving voltage V_{PIXEL}_{_{—}}_{POSITIVE}. Meanwhile, the switch unit 365 switches the first output terminal OP1 to output the voltage V_{PH} of the first voltage source V1, and the second output terminal OP2 to output the voltage V_{PL} of the second voltage source V2 according to the switch control signal CTRL. Therefore, before the source driver 330 outputs the driving voltage V_{PIXEL}_{_{—}}_{POSITIVE}, the voltage level of the first data line D1 can be raised to the voltage V_{PH} in advance through the first dummy switch SW1 for reducing the power consumption of the source driver 330. Conversely, when display data of a display unit of the first data line D1 is corresponding to a negative driving voltage V_{PIXEL}_{_{—}}_{POSITIVE}, the switch unit 365 then switches the first output terminal OP1 to output the voltage V_{PL} of the second voltage source V2, and the second output terminal OP2 to output the voltage V_{PH} of the first voltage source V1 according to the switch control signal CTRL for lowering the voltage level of the first data line D1 to the voltage V_{PL} in advance through the first dummy switch SW1. Furthermore, with the arrangement of the pre-charge circuit 360 of the present invention, the voltage levels of adjacent data lines can be pre-charged to the voltages with different polarities by utilizing the same control signal S3, so the dot-inversion driving method can be applied.

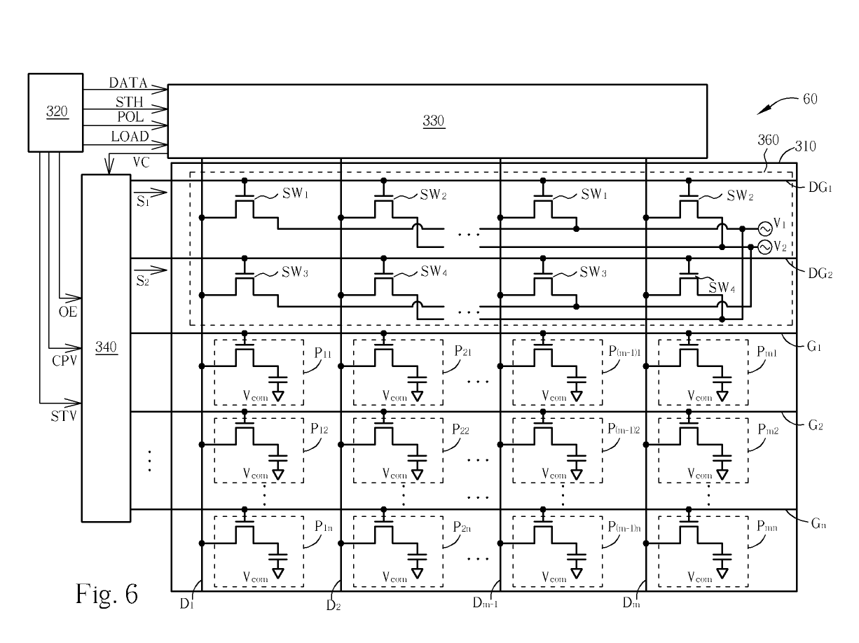

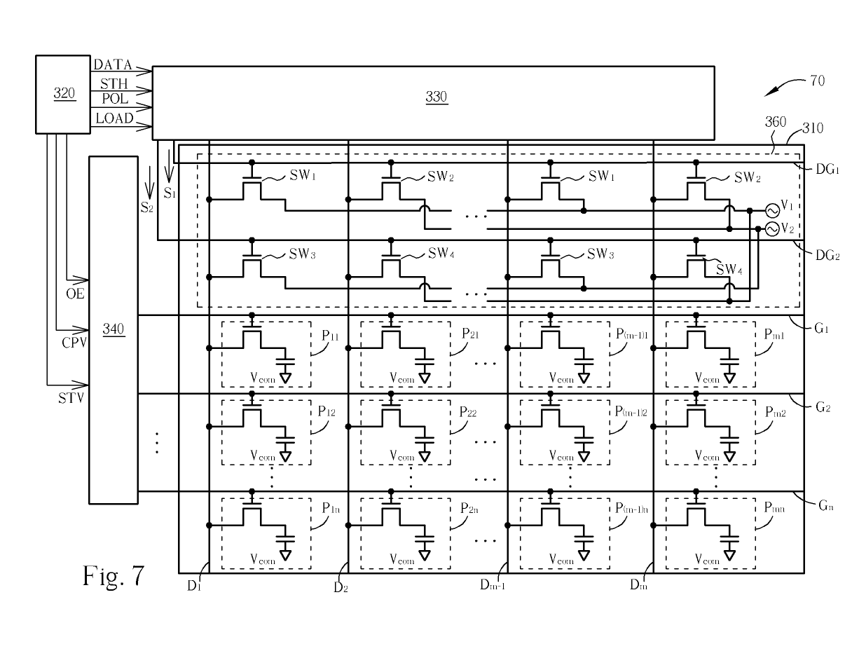

Therefore, the LCD device 30 of the present invention raises or lowers the voltage level of the data lines to specific values for reducing the energy needed to be provided by the source driver. Certainly, appropriate modifications can be made according to various demands, and are all included in the range of the present invention. For example, please refer to FIG. 6 and FIG. 7. FIG. 6 and FIG. 7 are schematic diagrams of LCD devices 60 and 70 driven by pre-charge procedure according to embodiments of the present invention. In FIG. 6, the pre-charge controller of the LCD device 60 outputs the first control signal S1 and the second control signal S2 according to a virtual control signal VC outputted by the source driver. In FIG. 7, the pre-charge controller of the LCD device 70 is integrated in the source driver.

As mentioned above, whenever polarity reversal is performed, the LCD device of the present invention utilizes the pre-charge controller and the pre-charge circuit to raise or lower the voltage level of the data lines to specific values in advance for reducing the energy needed to be provided by the source driver. Furthermore, the pre-charge circuit of the present invention utilizes the external voltage sources to achieve the pre-charge procedure, and thus the dynamic current passing through the source driver can be reduced greatly, so as to improve the heat dissipation problem of the source driver in large-size panel applications.

Those skilled in the art will readily observe that numerous modifications and alterations of the device and method may be made while retaining the teachings of the invention.

What is claimed is:

1. An LCD device driven by a pre-charge procedure comprising:
a source driver for generating data signals corresponding to display images;
a gate driver for generating gate signals;
a plurality of parallel data lines coupled to the source driver for receiving the data signals;
a plurality of parallel gate lines, coupled to the gate driver and crossed with the plurality of data lines perpendicularly, for receiving the gate signals;
a plurality of data switches, each comprising:
a first end coupled to a storage unit;
a second end coupled to a data line of the plurality of data lines; and
a control end coupled to a gate line of the plurality of gate lines, wherein the data switch controls a signal connection between the second end and the first end according to a signal of the gate line received by the control end;
a pre-charge controller for generating a plurality of control signals;
a plurality of dummy gate lines, coupled to the pre-charge controller and parallel to the plurality of gate lines, for receiving the plurality of control signals generated by the pre-charge controller;
a plurality of voltage sources for providing a plurality of voltage levels; and
a plurality of dummy switches, each comprising:
a first end coupled to a voltage source of the plurality of voltage sources;
a second end coupled to a data line of the plurality of data lines; and
a control end coupled to a dummy gate line of the plurality of dummy gate lines, wherein the dummy switch controls a signal connection between the second end and the first end according to a signal of the dummy gate line received by the control end.

2. The LCD device of claim 1, wherein each of the plurality of data switches is a thin film transistor (TFT).

3. The LCD device of claim 1, wherein each of the plurality of dummy switches is a thin film transistor (TFT).

4. The LCD device of claim 1, wherein the pre-charge controller is set in the source driver.

5. The LCD device of claim 1, wherein the pre-charge controller is set in the gate driver.

6. The LCD device of claim 5, wherein the pre-charge controller generates the plurality of control signals according to signals outputted by the source driver.

7. The LCD device of claim 1, wherein the storage unit is a liquid crystal capacitor.

8. An LCD device driven by a pre-charge procedure comprising:
a source driver for generating data signals corresponding to display images;
a gate driver for generating gate signals;
a plurality of parallel data lines coupled to the source driver for receiving the data signals;
a plurality of parallel gate lines, coupled to the gate driver and crossed with the plurality of data lines perpendicularly, for receiving the gate signals;
a plurality of data switches, each comprising:
a first end coupled to a storage unit;
a second end coupled to a data line of the plurality of data lines; and
a control end coupled to a gate line of the plurality of gate lines, wherein the data switch controls a signal connection between the second end and the first end according to a signal of the gate line received by the control end;
a pre-charge controller for generating a control signal;
a dummy gate line, coupled to the pre-charge controller and parallel to the plurality of gate lines, for receiving the control signal generated by the pre-charge controller;
a plurality of voltage sources for providing a plurality of voltage levels;
a switch unit coupled to the plurality of voltage sources for switching to output a voltage of the plurality of voltage sources according to a second control signal; and
a plurality of dummy switches, each comprising:
a first end coupled to the switch unit;
a second end coupled to a data line of the plurality of data lines; and
a control end coupled to the dummy gate line, wherein the dummy switch controls a signal connection between the second end and the first end according to a signal of the dummy gate line received by the control end.

9. The LCD device of claim 8, wherein each of the plurality of data switches is a thin film transistor (TFT).

10. The LCD device of claim 8, wherein each of the plurality of dummy switches is a thin film transistor (TFT).

11. The LCD device of claim 8, wherein the pre-charge controller is set in the source driver.

12. The LCD device of claim 8, wherein the pre-charge controller is set in the gate driver.

13. The LCD device of claim 12, wherein the pre-charge controller generates the control signal according to signals outputted by the source driver.

14. The LCD device of claim 8, wherein the storage unit is a liquid crystal capacitor.
